(19) United States
(12) Patent Application Publication
(10) Pub. No.: US 2021/0027380 A1
(43) Pub. Date: Jan. 28, 2021

(54) INFORMATION ACQUISITION METHOD, APPARATUS AND ELECTRONIC DEVICE

(71) Applicant: BOE TECHNOLOGY GROUP CO., LTD., Beijing (CN)

(72) Inventor: Hui LI, Beijing (CN)

(21) Appl. No.: 16/924,778

(22) Filed: Jul. 9, 2020

(30) Foreign Application Priority Data
Jul. 23, 2019 (CN) 201910666802.9

(51) Int. Cl. G06Q 40/06; G06F 16/2457

(52) U.S. Cl. CPC G06Q 40/06; G06F 16/2457

(57) ABSTRACT

The present disclosure provides an information acquisition method, apparatus, and electronic device. The method includes: acquiring a virtual business object to be queried, and a query condition corresponding to the virtual business object; and acquiring corresponding information from a first storage space or a second storage space according to the query condition and sending the corresponding information to a user. In some embodiments, when the query condition is a basic query condition, business basic information corresponding to the virtual business object is acquired from the first storage space, and sent to a user. In some embodiments, when the query condition is an evaluation query condition, business evaluation information corresponding to the virtual business object is acquired from the first storage space, and sent to the user. In some embodiments, when the query condition is a net value query condition, business net value information corresponding to the virtual business object is acquired from the second storage space, and sent to the user.

### CROSS-REFERENCE TO RELATED APPLICATION(S)

This application claims priority to Chinese Application No. 201910666802.9, entitled “INFORMATION ACQUISITION METHOD, APPARATUS AND ELECTRONIC DEVICE” and filed on Jul. 23, 2019, which is incorporated herein by reference in its entirety.

### TECHNICAL FIELD

The present disclosure relates to the technical field of financial services, and in particular, to an information acquisition method, apparatus and electronic device.

### BACKGROUND

Public offering of fund refers to a securities investment fund that raises funds from public investors in a public way and uses securities as an investment object. Public offering of fund is recruited by means of mass communication. The promoters gather public funds to set up investment funds and make securities investments. Under the strict supervision of laws, these funds have industry regulations such as information disclosure, profit distribution, and operational restrictions.

At present, ordinary users have less access to information of public offering of fund. When a bank is marketing fund wealth management products, the products are usually recommended by client managers manually. The professional knowledge, quality, and credibility of the client managers are uneven, which makes customers have less basis for judgment when purchasing fund products, and be susceptible to tendency interference. The customer's thinking process is relatively long, wasting customers' time.

### SUMMARY

An embodiment of the present disclosure discloses an information acquisition method, including: acquiring a virtual business object to be queried and a query condition corresponding to the virtual business object;

when the query condition is a basic query condition, acquiring business basic information corresponding to the virtual business object from the first storage space, and sending the business basic information to a user;

when the query condition is an evaluation query condition, acquiring business evaluation information corresponding to the virtual business object from the first storage space, and sending the business evaluation information to the user;

when the query condition is a net value query condition, acquiring business net value information corresponding to the virtual business object from the second storage space, and sending the business net value information to the user.

In some embodiments, before the step of acquiring a virtual business object to be queried and a query condition corresponding to the virtual business object, the method further includes:

acquiring business data information associated with the virtual business object from a specified data source;

extracting, from the business data information, the business basic information, the business evaluation information and/or the business net value information corresponding to the virtual business object;

storing the business basic information and the business evaluation information in the first storage space, and storing the business net value information in the second storage space;

establishing a first mapping relationship between the business basic information and the business evaluation information and the virtual business object in the first storage space, and establishing a second mapping relationship between the business net value information and the virtual business object in the second storage space.

In some embodiments, the step of acquiring business basic information corresponding to the virtual business object from the first storage space includes:

according to the first mapping relationship, acquiring the business basic information corresponding to the virtual business object from the first storage space;

The step of acquiring business evaluation information corresponding to the virtual business object from the first storage space includes:

according to the first mapping relationship, acquiring the business evaluation information corresponding to the virtual business object from the first storage space.

In some embodiments, the step of acquiring business net value information corresponding to the virtual business object from the second storage space includes:

according to the second mapping relationship, acquiring the business net value information corresponding to the virtual business object from the second storage space.

In some embodiments, the business data information includes semi-structured data information and unstructured data information, and the step of extracting, from the business data information, the business basic information, the business evaluation information and the business net value information corresponding to the virtual business object includes:

performing structuring processing on the semi-structured data to obtain a processing result;

acquiring the business basic information and the business net value information corresponding to the virtual business object according to the processing result;

extracting the business evaluation information from the unstructured data information by using a pre-configured rule character string.

An embodiment of the present disclosure discloses an information acquisition apparatus, including:

a query condition acquisition module configured to acquire a virtual business object to be queried and a query condition corresponding to the virtual business object;

a basic information acquisition module configured to, when the query condition is a basic query condition, acquire business basic information corresponding to the virtual business object from the first storage space, and send the business basic information to a user;

an evaluation information acquisition module configured to, when the query condition is an evaluation query condition, acquire business evaluation information corresponding to the virtual business object from the first storage space, and send the business evaluation information to the user;

a business net value acquisition module configured to, when the query condition is a net value query condition, acquire business net value information corresponding to the virtual business object from the second storage space, and send the business net value information to the user.

In some embodiments, the apparatus further includes:

a data information acquisition module configured to, acquire business data information associated with the virtual business object from a specified data source;

a business information extraction module configured to, extract, from the business data information, the business basic information, the business evaluation information and the business net value information corresponding to the virtual business object;

a business information storage module configured to, store the business basic information and the business evaluation information in the first storage space, and store the business net value information in the second storage space;

a mapping relationship establishing module configured to, establish a first mapping relationship between the business basic information and the business evaluation information and the virtual business object in the first storage space, and establish a second mapping relationship between the business net value information and the virtual business object in the second storage space.

In some embodiments, the basic information acquisition module includes:

a basic information acquisition submodule configured to, according to the first mapping relationship, acquire the business basic information corresponding to the virtual business object from the first storage space;

The evaluation information acquisition module includes:

an evaluation information acquisition submodule configured to, according to the first mapping relationship, acquire the business evaluation information corresponding to the virtual business object from the first storage space.

In some embodiments, the business net value acquisition module includes:

a business net value acquisition submodule configured to, according to the second mapping relationship, acquire the business net value information corresponding to the virtual business object from the second storage space.

In some embodiments, the business data information includes semi-structured data information and unstructured data information, and the business information extraction module includes:

a processing result acquisition submodule configured to perform structuring processing on the semi-structured data to obtain a processing result;

a basic and net value information acquisition submodule configured to acquire the business basic information and the business net value information corresponding to the virtual business object according to the processing result;

a business evaluation information extraction submodule configured to extract the business evaluation information from the unstructured data information by using a pre-configured rule character string.

An embodiment of the present disclosure also discloses an electronic device, including: a processor, a memory, and a computer program stored on the memory and executable by the processor, characterized in that the processor executes the program to implement one or more of the above information acquisition methods.

### BRIEF DESCRIPTION OF THE DRAWINGS

FIG. 1 shows a flowchart of steps of an information acquisition method provided by an embodiment of the present disclosure;

FIG. 2a shows a schematic diagram of fund information provided by an embodiment of the present disclosure;

FIG. 2b shows a schematic diagram of graph question and answer provided by an embodiment of the present disclosure;

FIG. 3 shows a schematic structural diagram of an information acquisition apparatus provided by an embodiment of the present disclosure; and

FIG. 4 shows a schematic block diagram of hardware of an electronic device provided by an embodiment of the present disclosure.

### DETAILED DESCRIPTION

In order to make the above objects, features and advantages of the disclosure more obvious and understandable, the present disclosure will be further described in detail in conjunction with the accompanying drawings and specific embodiments.

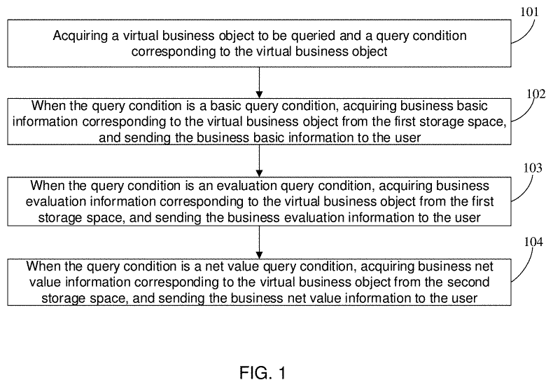

Referring to FIG. 1, it shows a flowchart of steps of an information acquisition method provided by an embodiment of the present disclosure, which may specifically include the following steps:

Step 101: a virtual business object to be queried and a query condition corresponding to the virtual business object are acquired.

In the embodiment of the present disclosure, the virtual business object may refer to virtual objects such as funds, stocks, bonds, and the like.

Some embodiments of the present disclosure aim to establish a knowledge graph corresponding to a virtual business object, and when a user queries related information, the user can be provided with related query information.

The query condition refers to a query condition input by a user, and may include a basic query condition, an evaluation query condition, a net value query condition, and the like. Specifically, it will be described in detail in the following steps.

In a specific implementation of the present disclosure, the relevant information of the virtual business object may be stored in advance. Specifically, it will be described in detail in the following specific implementation manners.

In a specific implementation of the present disclosure, before the above step 101, the method may further include:

Step A1: business data information associated with the virtual business object is acquired from a specified data source.

In the embodiments of the present disclosure, the business data information refers to data information associated with a virtual business object. The business data information may be business net value information. For example, for a fund, it may be fund net value (including current fund net value and historical fund net value); for a stock, it may be the stock price (including current stock price and historical stock price), and the like. The business data information may also be business evaluation information, for example, the views and opinions of major bloggers on funds and stocks.

The specified data source refers to a data source from which the business data information associated with a virtual business object may be acquired, such as major securities APPs (Applications), and the like. Specifically, it may be determined according to business needs, which is not limited in the embodiments of the present disclosure.

Data sources mainly include semi-structured data and unstructured data.

Semi-structured data may be crawled using the Scrapy framework.

Unstructured data generally refers to investment research reports, which may be acquired through manual acquisition plus crawler acquisition and other methods.

After acquiring the business data information associated with the virtual business object from the specified data source, step A2 is executed.

Step A2: the business basic information, the business evaluation information and the business net value information corresponding to the virtual business object are extracted from the business data information.

After acquiring the business data information, the business basic information, the business evaluation information and the business net value information corresponding to the virtual business object may be extracted from the business data information.

The business data information acquired from the specified data source contains semi-structured data information and unstructured data information. Specifically, the extraction process may be described as the following specific implementation manner.

In a specific implementation of the present disclosure, the above step A2 may include:

Sub-step B1: structuring processing on the semi-structured data is performed to obtain a processing result;

Sub-step B2: the business basic information and the business net value information corresponding to the virtual business object are acquired according to the processing result;

Sub-step B3: the business evaluation information is extracted from the unstructured data information by using a pre-configured rule character string.

In the embodiment of the present disclosure, structuring processing is performed on the semi-structured data to obtain a processing result, and according to the processing result, the business basic information and the business net value information corresponding to the virtual business object are acquired.

For unstructured data, regular expressions may be used to extract structured information, such as fund views (that is, business evaluation information). Regular expressions extract substrings from strings based on pattern matching, and can find specific text in documents or input fields. A regular expression is a logical formula for operating on a string. It uses pre-defined specific characters and combinations of these specific characters to form a “rule string”. This “rule string” is used to express a filtering logic for the string.

After acquiring the structured data information, the pre-configured rule character string may be used to extract the business evaluation information from the unstructured data information.

After extracting the business basic information, the business evaluation information, and the business net value information corresponding to the virtual business object from the business data information, step A3 is executed.

Step A3: the business basic information and the business evaluation information are stored in the first storage space, and the business net value information is stored in the second storage space.

The first storage space refers to a storage space for storing the business basic information and the business evaluation information corresponding to the virtual business object.

The second storage space refers to a storage space for storing the business net value information corresponding to the virtual business object.

In some embodiments of the present disclosure, the first storage space may be Neo4j, and the second storage space may be MySQL. The fund data, especially the net value data, needs to be updated regularly every day. Therefore, Neo4j and MySQL need to be used together for storage. Entity, relationship, and attribute information are stored in Neo4j, and net value information is stored in MySQL. The two are linked by foreign keys (such as code identification, and the like).

After the business basic information and the business evaluation information are obtained, the business basic information and the business evaluation information may be stored in the first storage space, and after the business net value information is obtained, the business net value information may be stored in the second storage space.

After storing the business basic information and the business evaluation information in the first storage space, and storing the business net value information in the second storage space, step A4 is executed.

Step A4: a first mapping relationship between the business basic information and the business evaluation information and the virtual business object is established in the first storage space, and a second mapping relationship between the business net value information and the virtual business object is established in the second storage space.

Each virtual business object has corresponding code identification, such as fund code, 003254, 006280, and the like.

The first mapping relationship refers to a mapping relationship between the virtual business object and the business basic information, and between the virtual business object and the business evaluation information.

The second mapping relationship refers to a mapping relationship between the virtual business object and the business net value information.

After storing the business basic information and the business evaluation information in the first storage space, and storing the business net value information in the second storage space, the code identification corresponding to the virtual business object may be combined to assign the code identification of the virtual business object to the business basic information and the business evaluation information corresponding to the virtual business object in the first storage space, and assign the code identification of the virtual business object to the business net value information in the second storage space, so that a second mapping relationship between virtual business objects and business net value information is established in the second storage space.

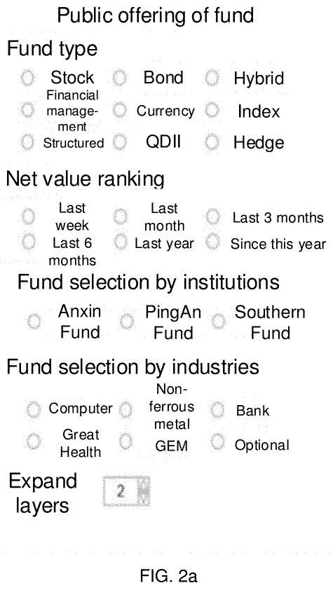

Next, the above-mentioned business basic information, business evaluation information and business net value information will be described as follows with reference to FIG. 2a.

Referring to FIG. 2a, a schematic diagram of fund information provided by an embodiment of the present disclosure is shown. As shown in FIG. 2a, for public offering of fund, the business basic information of public offering of fund may include fund type, such as stock type, bond type, hybrid type, financial management type, and the like. The business net value information of public offering of fund may include the fund's net value, and the fund's net value for a period of time, such as last week, last month, last three months, and the like, may be stored in the second storage space. The business evaluation information of public offering of fund may be, for example, information on fund selection behaviors by major institutions and industries, such as Anxin Fund, Ping An Fund, and Southern Fund; or computer, non-ferrous metal, bank, self-selection, and the like.

Of course, the business basic information, business evaluation information, and business net value information of the virtual business object may also be other types of information. Specifically, it will depend on the actual situation, which is not limited in the embodiments of the present disclosure.

After acquiring the virtual business object to be queried and the query condition corresponding to the virtual business object, step 102, or step 103, or step 104 is performed.

Step 102: when the query condition is a basic query condition, business basic information corresponding to the virtual business object is acquired from the first storage space, and sent to the user.

Basic query conditions refer to the conditions for querying business basic information corresponding to virtual business objects.

When the query condition corresponding to the virtual business object is the basic query condition, the business basic information corresponding to the virtual business object may be acquired directly from the first storage space, and sent to the user. For example, referring to FIG. 2b, a schematic diagram of a graph question and answer provided by an embodiment of the present disclosure is shown. For example, when a user asks “What type of fund is 003254”, the corresponding result, such as “bond type”, may be acquired and pushed to the user. When a user asks “Who is the manager of Furong Currency Fund”, the corresponding result, such as “Zhang San”, may be acquired and pushed to the user. When the user further asks “What other funds does he represent”, the corresponding search results, such as “Dongfang Gold Ingot Currency”, “Jinxin Minfa Currency”, “Agricultural Bank Currency”, may be pushed.

It can be understood that the above examples are only examples enumerated for better understanding of the technical solutions of the embodiments of the present disclosure, and are not intended to be the only limitations on the embodiments of the present disclosure.

Of course, since the first mapping relationship between the virtual business object and the business basic information is stored in the first storage space, the above step 102 may include:

Sub-step C1: according to the first mapping relationship, business basic information corresponding to the virtual business object is acquired from the first storage space.

In the embodiment of the present disclosure, after acquiring the basic query condition input by the user, the business basic information corresponding to the basic query condition may be searched from the first storage space according to the first mapping relationship between the virtual business object and the business basic information.

Step 103: when the query condition is an evaluation query condition, business evaluation information corresponding to the virtual business object is acquired from the first storage space, and sent to the user.

Evaluation query conditions refer to conditions for querying business evaluation information corresponding to virtual business objects.

When the query condition corresponding to the virtual business object is the evaluation query condition, the business evaluation information corresponding to the virtual business object may be acquired directly from the first storage space and sent to the user. For example, as shown in FIG. 2b, when the user asks “Galaxy Return Bonds and 000003 yield comparison”, the corresponding results may be acquired and pushed to the user, such as “Galaxy Return Bonds (519662) Date: 01-31, net value: 1.462, last week: −0.2% , last month: 0.48%, last three months: 17.91%”, “CNOOC Convertible Bonds (000003) Date: 01-31, net value: 0.668, last week: −0.15%, last month: 5.53%, last three months: 5.03%”. When the user asks “How about the yield of Southern Finance”, the corresponding results may be acquired and pushed to the user, such as “Southern Finance (202304) Date: 01-31, 7 days Yield: 3.54%, last week: 0.07%, last month: 0.28%, last three months: 0.87%”.

It can be understood that the above examples are only examples enumerated for better understanding of the technical solutions of the embodiments of the present disclosure, and are not intended to be the only limitations on the embodiments of the present disclosure.

Of course, since the first mapping relationship between the virtual business object and the business evaluation information is stored in the first storage space, the above step 103 may include:

Sub-step D1: according to the first mapping relationship, business evaluation information corresponding to the virtual business object is acquired from the first storage space.

In the embodiment of the present disclosure, after acquiring the evaluation query condition input by the user, the business evaluation information corresponding to the evaluation query condition may be searched from the first storage space according to the first mapping relationship between the virtual business object and the business evaluation information.

Step 104: when the query condition is a net value query condition, business net value information corresponding to the virtual business object is acquired from the second storage space, and sent to the user.

Net value query conditions refer to conditions for querying business net value information corresponding to virtual business objects.

When the query condition corresponding to the virtual business object is the net value query condition, the business net value information corresponding to the virtual business object may be acquired directly from the second storage space, and sent to the user. For example, as shown in FIG. 2b , when the user asks “How about net value of 002168”, the corresponding results may be acquired and pushed to the user, such as “Harvest Smart Car Stock (002168) Date: 01-31, net value: 1.2400”.

Of course, the user may also query the historical net value of the virtual business object, such as in the last month, in the last year, and the like. Specifically, it can be determined according to the actual situation.

In the embodiment of the present disclosure, the business basic information (such as fund manager, fund manager qualifications, and the like) and the business evaluation information (such as the professional's view on whether the fund can be held) corresponding to the virtual business object (such as fund, and the like) are stored in the first storage space, and the business net value information (such as the current net value or historical net value of the fund) corresponding to the virtual business object is stored in the second storage space. The above information can provide reference and judgment basis for users to purchase funds, and save customers' time.

According to the information acquisition method provided by the embodiment of the present disclosure, by acquiring a virtual business object to be queried and a query condition corresponding to the virtual business object, when the query condition is a basic query condition, business basic information corresponding to the virtual business object is acquired from the first storage space, and sent to the user; when the query condition is an evaluation query condition, business evaluation information corresponding to the virtual business object is acquired from the first storage space, and sent to the user; when the query condition is a net value query condition, business net value information corresponding to the virtual business object is acquired from the second storage space, and sent to the user. In the embodiment of the present disclosure, the business basic information (such as fund manager, fund manager qualifications, and the like) and the business evaluation information (such as the professional's view on whether the fund can be held) corresponding to the virtual business object (such as fund, and the like) are stored in the first storage space, and the business net value information (such as the current net value or historical net value of the fund) corresponding to the virtual business object is stored in the second storage space. The above information can provide reference and judgment basis for users to purchase funds, and save customers' time.

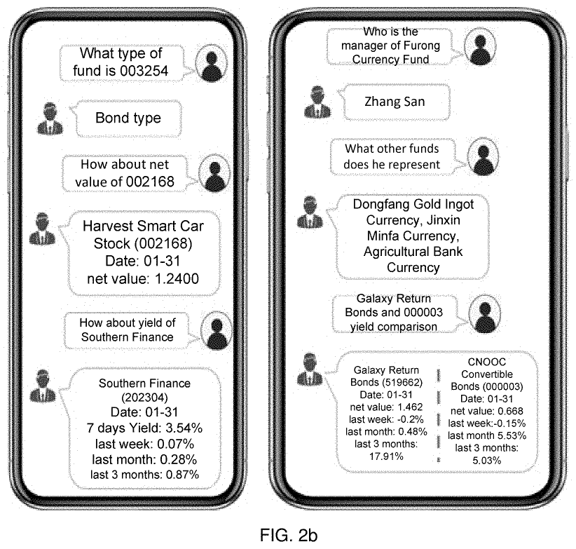

Referring to FIG. 3, it shows a schematic structural diagram of an information acquisition apparatus provided by an embodiment of the present disclosure, which may specifically include the following modules:

a query condition acquisition module 210 configured to acquire a virtual business object to be queried and a query condition corresponding to the virtual business object;

a basic information acquisition module 220 configured to, when the query condition is a basic query condition, acquire business basic information corresponding to the virtual business object from the first storage space, and send the business basic information to a user;

an evaluation information acquisition module 230 configured to, when the query condition is an evaluation query condition, acquire business evaluation information corresponding to the virtual business object from the first storage space, and send the business evaluation information to the user;

a business net value acquisition module 240 configured to, when the query condition is a net value query condition, acquire business net value information corresponding to the virtual business object from the second storage space, and send the business net value information to the user.

In some embodiments, the information acquisition apparatus may further include:

a data information acquisition module configured to, acquire business data information associated with the virtual business object from a specified data source;

a business information extraction module configured to, extract, from the business data information, the business basic information, the business evaluation information and the business net value information corresponding to the virtual business object;

a business information storage module configured to, store the business basic information and the business evaluation information in the first storage space, and store the business net value information in the second storage space;

a mapping relationship establishing module configured to, establish a first mapping relationship between the business basic information and the business evaluation information and the virtual business object in the first storage space, and establish a second mapping relationship between the business net value information and the virtual business object in the second storage space.

In some embodiments, the basic information acquisition module 220 includes:

a basic information acquisition submodule configured to, according to the first mapping relationship, acquire the business basic information corresponding to the virtual business object from the first storage space;

The evaluation information acquisition module 230 includes:

an evaluation information acquisition submodule configured to, according to the first mapping relationship, acquire the business evaluation information corresponding to the virtual business object from the first storage space.

In some embodiments, the business net value acquisition module 240 includes:

a business net value acquisition submodule configured to, according to the second mapping relationship, acquire the business net value information corresponding to the virtual business object from the second storage space.

In some embodiments, the business data information includes semi-structured data information and unstructured data information, and the business information extraction module includes:

a processing result acquisition submodule configured to perform structuring processing on the semi-structured data to obtain a processing result;

a basic and net value information acquisition submodule configured to acquire the business basic information and the business net value information corresponding to the virtual business object according to the processing result;

a business evaluation information extraction submodule configured to extract the business evaluation information from the unstructured data information by using a pre-configured rule character string.

According to the information acquisition apparatus provided by the embodiment of the present disclosure, by acquiring a virtual business object to be queried and a query condition corresponding to the virtual business object, when the query condition is a basic query condition, business basic information corresponding to the virtual business object is acquired from the first storage space, and sent to the user; when the query condition is an evaluation query condition, business evaluation information corresponding to the virtual business object is acquired from the first storage space, and sent to the user; when the query condition is a net value query condition, business net value information corresponding to the virtual business object is acquired from the second storage space, and sent to the user. In the embodiment of the present disclosure, the business basic information (such as fund manager, fund manager qualifications, and the like) and the business evaluation information (such as the professional's view on whether the fund can be held) corresponding to the virtual business object (such as fund, and the like) are stored in the first storage space, and the business net value information (such as the current net value or historical net value of the fund) corresponding to the virtual business object is stored in the second storage space. The above information can provide reference and judgment basis for users to purchase funds, and save customers' time.

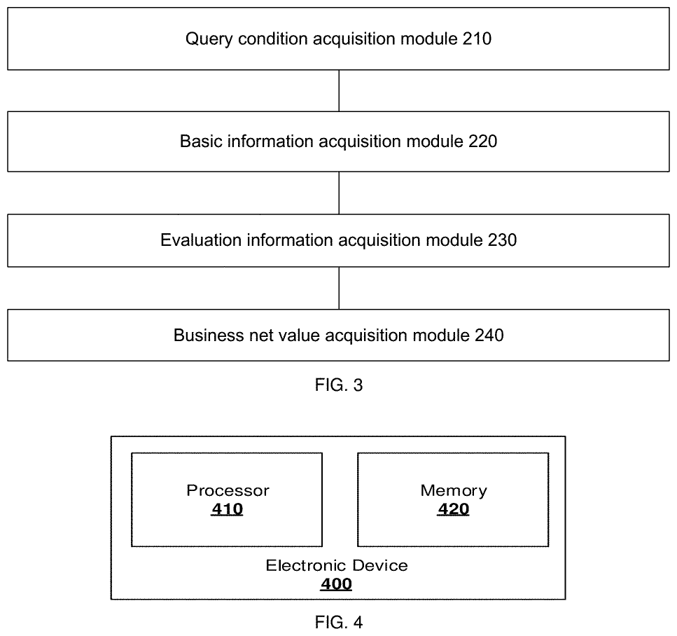

FIG. 4 shows a schematic hardware block diagram of an electronic device 400 provided by an embodiment of the present disclosure. As shown in FIG. 4, the electronic device 400 may include a processor 410 and a memory 420. A computer program executable by the processor 410 is stored on the memory 420, and when the processor 410 executes the program, the information acquisition method in the foregoing embodiment is implemented. In addition, in some embodiments, the first storage space and/or the second storage space may be at least a part of the memory 420 or at least a part of a storage device external to the electronic device 400.

According to embodiments of the present disclosure, an information acquisition method, apparatus, and electronic device are provided to solve the following problems in the related art: customers have less basis for judgment when purchasing fund products, and are susceptible to tendency interference, and the customer's thinking process is relatively long, wasting customers' time.

According to the information acquisition method, apparatus and electric device provided by the embodiment of the present disclosure, by acquiring a virtual business object to be queried and a query condition corresponding to the virtual business object, when the query condition is a basic query condition, business basic information corresponding to the virtual business object is acquired from the first storage space, and sent to the user; when the query condition is an evaluation query condition, business evaluation information corresponding to the virtual business object is acquired from the first storage space, and sent to the user; when the query condition is a net value query condition, business net value information corresponding to the virtual business object is acquired from the second storage space, and sent to the user. In the embodiment of the present disclosure, the business basic information (such as fund manager, fund manager qualifications, and the like) and the business evaluation information (such as the professional's view on whether the fund can be held) corresponding to the virtual business object (such as fund, and the like) are stored in the first storage space, and the business net value information (such as the current net value or historical net value of the fund) corresponding to the virtual business object is stored in the second storage space. The above information can provide reference and judgment basis for users to purchase funds, and save customers' time.

The embodiments in this specification are described in a progressive manner. Each embodiment focuses on the differences from other embodiments, and the same or similar parts between the embodiments may refer to each other.

Finally, it should also be noted that relational terms such as first and second herein are used only to distinguish one entity or operation from another entity or operation, and do not necessarily require or imply that there is any such actual relationship or order among these entities or operations. In addition, the terms “include”, “including” or any other variants thereof are intended to cover non-exclusive inclusion, so that a process, method, article or device including a series of elements includes not only those elements, and it also includes other elements not explicitly listed, or elements inherent to such a process, method, product, or device. Without more restrictions, an element limited by the sentence “including a . . . ” does not exclude that there are other identical elements in the process, method, product, or device that includes the element.

The information acquisition method, information acquisition apparatus, and electronic device provided by the present disclosure have been described in detail above. In the present disclosure, specific embodiments are used to describe the principle and implementation manners of the present disclosure. The description of the foregoing embodiments is merely used to help understand the method and core idea of the present disclosure. Meanwhile, for those skilled in the art, the idea of the present disclosure may have variations in specific implementation manners and application scope. To sum up, the content of the description should not be construed as a limitation on the present disclosure.

I/we claim:

1. An information acquisition method, comprising:
acquiring a virtual business object to be queried and a query condition corresponding to the virtual business object; and
acquiring corresponding information from a first storage space or a second storage space according to the query condition and sending the corresponding information to a user.

2. The method of claim 1, wherein the step of acquiring corresponding information from a first storage space or a second storage space according to the query condition and sending the corresponding information to the user comprises:
when the query condition is a basic query condition, acquiring business basic information corresponding to the virtual business object from the first storage space, and sending the business basic information to the user.

3. The method of claim 1, wherein the step of acquiring corresponding information from a first storage space or a second storage space according to the query condition and sending the corresponding information to the user comprises:
when the query condition is an evaluation query condition, acquiring business evaluation information corresponding to the virtual business object from the first storage space, and sending the business evaluation information to the user.

4. The method of claim 1, wherein the step of acquiring corresponding information from a first storage space or a second storage space according to the query condition and sending the corresponding information to the user comprises:
when the query condition is a net value query condition, acquiring business net value information corresponding to the virtual business object from the second storage space, and sending the business net value information to the user.

5. The method of claim 1, wherein before the step of acquiring a virtual business object to be queried and a query condition corresponding to the virtual business object, the method further comprises:
acquiring business data information associated with the virtual business object from a specified data source;
extracting, from the business data information, a business basic information, a business evaluation information and/or a business net value information corresponding to the virtual business object;
storing the business basic information and the business evaluation information in the first storage space, and storing the business net value information in the second storage space.

6. The method of claim 5, further comprising:
establishing a first mapping relationship between the business basic information and the business evaluation information and the virtual business object in the first storage space, and establishing a second mapping relationship between the business net value information and the virtual business object in the second storage space.

7. The method of claim 6, further comprising:
according to the first mapping relationship, acquiring the business basic information corresponding to the virtual business object from the first storage space.

8. The method of claim 6, further comprising:
according to the first mapping relationship, acquiring the business evaluation information corresponding to the virtual business object from the first storage space.

9. The method of claim 6, further comprising:
according to the second mapping relationship, acquiring the business net value information corresponding to the virtual business object from the second storage space.

10. The method of claim 6, wherein the business data information comprises semi-structured data information and unstructured data information.

11. The method of claim 10, further comprising:
performing structuring processing on the semi-structured data to obtain a processing result;
acquiring the business basic information and the business net value information corresponding to the virtual business object according to the processing result; and
extracting the business evaluation information from the unstructured data information by using a pre-configured rule character string.

12. An electronic device, comprising:
a processor;
a memory storing a computer program which, when executed by the processor, causes the processor to:
acquire a virtual business object to be queried and a query condition corresponding to the virtual business object; and
acquire corresponding information from a first storage space or a second storage space according to the query condition and send the corresponding information to a user.

13. The electronic device of claim 12, wherein the computer program, when executed by the processor, further causes the processor to:
when the query condition is a basic query condition, acquire business basic information corresponding to the virtual business object from the first storage space, and send the business basic information to the user.

14. The electronic device of claim 12, wherein the computer program, when executed by the processor, further causes the processor to:
when the query condition is an evaluation query condition, acquire business evaluation information corresponding to the virtual business object from the first storage space, and send the business evaluation information to the user.

15. The electronic device of claim 12, wherein the computer program, when executed by the processor, further causes the processor to:
when the query condition is a net value query condition, acquire business net value information corresponding to the virtual business object from the second storage space, and send the business net value information to the user.

16. The electronic device of claim 12, wherein the computer program, when executed by the processor, further causes the processor to:
acquire business data information associated with the virtual business object from a specified data source;
extract, from the business data information, a business basic information, a business evaluation information and/or a business net value information corresponding to the virtual business object;
store the business basic information and the business evaluation information in the first storage space, and store the business net value information in the second storage space.

17. The electronic device of claim 16, wherein the computer program, when executed by the processor, further causes the processor to:
establish a first mapping relationship between the business basic information and the business evaluation information and the virtual business object in the first storage space, and establish a second mapping relationship between the business net value information and the virtual business object in the second storage space.

18. The electronic device of claim 17, wherein the computer program, when executed by the processor, further causes the processor to:
according to the first mapping relationship, acquire the business basic information corresponding to the virtual business object from the first storage space.

19. The electronic device of claim 17, wherein the computer program, when executed by the processor, further causes the processor to:
according to the first mapping relationship, acquire the business evaluation information corresponding to the virtual business object from the first storage space.

20. The electronic device of claim 17, wherein the computer program, when executed by the processor, further causes the processor to:
according to the second mapping relationship, acquire the business net value information corresponding to the virtual business object from the second storage space.
